(19) United States
(12) Patent Application Publication
(10) Pub. No.: US 2026/0084125 A1
(43) Pub. Date: Mar. 26, 2026

(54) CONTINUOUS-FLOW MICROFLUIDIC HOMOGENIZATION DEVICE

(71) Applicant: Wenzhou University of Technology, Wenzhou (CN)

(72) Inventors: Haishao Chen, Wenzhou (CN); Yunyang Ye, Wenzhou (CN); Wenjie Peng, Wenzhou (CN); Leyong Jiang, Changsha (CN); zhonggen Su, Wenzhou (CN); Debin Liu, Yueqing (CN)

(21) Appl. No.: 19/083,372

(22) Filed: Mar. 18, 2025

(30) Foreign Application Priority Data
Sep. 26, 2024 (CN) 202411347353.9

(51) Int. Cl. B01F 33/301; B01F 33/302; B01F 35/10; B01F 35/32; B01F 35/75

(52) U.S. Cl. CPC B01F 33/3017; B01F 33/3021; B01F 35/1452; B01F 35/32; B01F 35/7547

(57) ABSTRACT

Disclosed is a continuous-flow microfluidic homogenization device, which includes a supporting component, wherein a disperser and an aligning component are fixedly mounted at a front end of the supporting component, the aligning component is positioned at a front end of the disperser, a conveying pipeline is fixedly mounted at a top end of the disperser, the supporting component includes synchronizing apparatuses and a transmission apparatus, the synchronizing apparatuses are symmetrically and fixedly mounted at a top front end of the transmission apparatus, the transmission apparatus includes a microfluidic homogenization device body, first racks, a placing base, a receiving measuring cup, an extending base frame, a butt joint head, a fourth gear, a second rack and hydraulic cylinders, the hydraulic cylinders are symmetrically and fixedly mounted at a top end of the microfluidic homogenization device body, and the placing base is fixedly mounted at a front end of the hydraulic cylinder.

### CROSS-REFERENCE TO RELATED APPLICATIONS

This application claims priority to Chinese Patent Application No. 202411347353.9, filed on Sep. 26, 2024, which is hereby incorporated by reference in its entirety.

### TECHNICAL FIELD

The present invention relates to the technical field of liquid processing, and specifically to a continuous-flow microfluidic homogenization device.

### BACKGROUND

A microfluidic homogenizer is an advanced nano-level emulsification and dispersion processing equipment and belongs to a new generation of high-pressure homogenizers.

The microfluidic homogenizer sprays tiny jets at high speed to produce strong shearing and impact effects on the material, thereby achieving homogenization of the material. Specifically, a liquid material is squeezed into a micron-sized slit (such as a Y-shaped channel of a diamond interaction cavity) by a plunger rod of a hydraulic booster pump in the homogenizer, forming a supersonic jet that collides and shears each other. During the impact, most of energy is released instantly, resulting in a huge pressure drop, so that liquid drops or powder particles in the liquid are refined to be distributed in a nanometer scale and are uniformly distributed in the liquid.

According to the Chinese Patent Application No. CN214346085U, an ultra-high pressure microfluidic nano-level homogenization equipment includes a hyperbaric chamber, a homogenization device and a pressurizing mechanism, wherein a pressurizing plug and a material plug are respectively arranged at a left end and a right end of the hyperbaric chamber, a piston for dividing the hyperbaric chamber into a pressurizing end and a material end is arranged inside the hyperbaric chamber, a pressure relief pipe and a drainage pipe are both arranged at a left end of the pressurizing end of the hyperbaric chamber, two sets of position sensors are respectively arranged at the left end of the pressurizing end and a right end of the material end of the hyperbaric chamber, a feed pipe and an exhaust pipe are both arranged at the right end of the material end of the hyperbaric chamber, the feed pipe is connected to a feed pump, a switch valve is arranged on the feed pipe, a switch valve is arranged on the exhaust pipe, and the homogenization device comprises a homogenizing switch valve and a homogenizing chamber.

At present, when the microfluidic homogenizer on the market is used, since the internal pipes are relatively thin and there is a lack of internal cleaning components on the microfluidic homogenizer, after each liquid processing, it is necessary to use external equipment to clean the inside. As a result, the existing microfluidic homogenizer cannot perform alternate alignment conveying and synchronous inner wall cleaning work when in use. Therefore, a device is required to improve the microfluidic homogenizer aiming at the problems.

### SUMMARY

In view of the problems in the prior art, the present invention provides a continuous-flow microfluidic homogenization device.

A technical solution adopted by the present invention for solving the technical problem is as follows. A continuous-flow microfluidic homogenization device includes a supporting component, wherein a disperser and an aligning component are fixedly mounted at a front end of the supporting component, the aligning component is positioned at a front end of the disperser, a conveying pipeline is fixedly mounted at a top end of the disperser, the supporting component includes synchronizing apparatuses and a transmission apparatus, the synchronizing apparatuses are symmetrically and fixedly mounted at a top front end of the transmission apparatus, the transmission apparatus includes a microfluidic homogenization device body, first racks, a placing base, a receiving measuring cup, an extending base frame, a butt joint head, a fourth gear, a second rack and hydraulic cylinders, the hydraulic cylinders are symmetrically and fixedly mounted at a top end of the microfluidic homogenization device body, the placing base is fixedly mounted at a front end of the hydraulic cylinder, the receiving measuring cup is slidably inserted at a top end of the placing base, the first racks are symmetrically and fixedly mounted at a top end of the placing base far away from the receiving measuring cup, the fourth gear is rotatably mounted at an opposite side end of the extending base frame, a top end of the second rack is slidably sleeved on a top end of the extending base frame, and the butt joint head is fixedly mounted between the two second racks.

Specifically, the synchronizing apparatus includes a guide wheel, a winding wheel, a first gear, supporting base frames, a second gear and a third gear, the third gear and the second gear are rotatably mounted at a right top end of the supporting base frame, the third gear is positioned in front of the second gear, the first gear is fixedly mounted at a left center of the second gear, the winding wheel is fixedly mounted at a left center of the third gear, and the guide wheel is rotatably mounted at a left front end of the supporting base frame.

Specifically, the aligning component includes a lower edge apparatus and a receiving apparatus, and the lower edge apparatus is fixedly mounted at a top end of the receiving apparatus.

Specifically, the lower edge apparatus includes connecting ropes, a nozzle, a covering plate, a vertical pipe, a supporting top plate and an electromagnetic water valve, the connecting ropes are symmetrically and fixedly mounted at a bottom rear end of the supporting top plate, the electromagnetic water valve is fixedly mounted at a top center of the supporting top plate, the vertical pipe is fixedly mounted at a bottom end of the electromagnetic water valve, the nozzle is fixedly mounted at a bottom end of the vertical pipe, and the covering plate is slidably sleeved on an outer ring of the vertical pipe.

Specifically, the receiving apparatus includes an extending side frame, a reset spring, button switches, a storage cavity and a one-way valve, the reset spring is fixedly mounted at a top front end of the extending side frame and is distributed in a ring shape, the one-way valve is fixedly mounted at a bottom front end of the extending side frame, the storage cavity is fixedly mounted at a top of the one-way valve, and the button switches are fixedly mounted at top ends of two sides of the storage cavity.

Specifically, the supporting base frames are symmetrically and fixedly mounted at a top front end of the microfluidic homogenization device body, one end of the connecting rope far away from the nozzle is connected to the winding wheel, a top end of the reset spring is connected to a bottom end of the supporting top plate, and the one-way valve is fixedly mounted at the top front end of the microfluidic homogenization device body.

Specifically, the butt joint head is horizontally aligned to the conveying pipeline, the third gear is meshed with the second gear, a transmission ratio of the second gear to the third gear is 1:10, and a top end of the first gear is aligned to a bottom end of the second rack.

Specifically, an iron ring is fixedly mounted at an outer ring of a top end of the storage cavity, a hole adapted to the vertical pipe is opened on a top end of the extending side frame, and the button switch is electrically connected to the electromagnetic water valve.

Specifically, each of the second rack and the first rack are meshed with the fourth gear, the receiving measuring cup, the butt joint head and the conveying pipeline are vertically aligned, and a magnetic ring is fixedly mounted at a bottom end of the covering plate.

Specifically, the placing base includes a plastic gasket, a supporting vertical plate and a threaded rod, the plastic gasket is fixedly mounted at two sides of a top end of the placing base, the threaded rod is threadedly inserted in a center of a side end of the supporting vertical plate, and the plastic gasket is fixedly mounted at a center of the opposite end of the threaded rod.

The beneficial effects of the present invention are as follows.

When the hydraulic cylinder is started, the receiving measuring may be driven to align with the conveying pipeline, so that the processed liquid is received, and when the receiving measuring cup is displaced reversely, the butt joint head may be in butt joint with the inside of the conveying pipeline, so that the liquid discharged from the inside of the conveying pipeline may directly enter the butt joint head, thereby avoiding the liquid discharged from the inside of the conveying pipe from being unable to be received, and completing alternate alignment conveying between the receiving measuring cup and the butt joint head.

The second rack may be driven to rotate when the second rack is displaced, so that the winding wheel may pull the connecting rope to drive the supporting top plate to move downwards, the covering plate covers the storage cavity, the nozzle may continuously move downwards in the storage cavity, and the nozzle may flush an inner wall of the storage cavity; and then when the microfluidic homogenization device body is started, water in the storage cavity is sent out through the conveying pipeline, and the synchronous cleaning of the pipeline in the microfluidic homogenization device body is completed.

### BRIEF DESCRIPTION OF DRAWINGS

The present invention is further described below with reference to the accompanying drawings and embodiments.

FIG. 1 is a schematic diagram of a three-dimensional structure of a main body according to the present invention from a front perspective;

FIG. 2 is a schematic diagram of a three-dimensional structure of a supporting component according to the present invention from a front perspective;

FIG. 3 is a schematic diagram of a three-dimensional structure of a synchronizing apparatus according to the present invention from a front perspective;

FIG. 4 is a schematic diagram of a three-dimensional structure of a transmission apparatus according to the present invention from a front perspective;

FIG. 5 is a schematic diagram of a three-dimensional structure of an aligning component according to the present invention from a front perspective;

FIG. 6 is a schematic diagram of a three-dimensional structure of a lower edge apparatus according to the present invention from a front perspective;

FIG. 7 is a schematic diagram of a three-dimensional structure of a receiving apparatus according to the present invention from a front perspective; and

FIG. 8 is a schematic diagram of a three-dimensional structure of a second embodiment of a placing base according to the present invention from a front perspective.

Reference numerals: 1: supporting component, 2: aligning component, 3: disperser, 4: conveying pipeline, 5: synchronizing apparatus, 6: transmission apparatus, 7: guide wheel, 8: winding wheel, 9: first gear, 10: supporting base frame, 11: second gear, 12: third gear, 13: microfluidic homogenization device body, 14: first rack, 15: placing base, 16: receiving measuring cup, 17: extending base frame, 18: butt joint head, 19: fourth gear, 20: second rack, 21: hydraulic cylinder, 22: lower edge apparatus, 23: receiving apparatus, 24: connecting rope, 25: nozzle, 26: covering plate, 27: vertical pipe, 28: supporting top plate, 29: electromagnetic water valve, 30: extending side frame, 31: reset spring, 32: button switch, 33: storage cavity, 34: one-way valve, 35: plastic gasket, 36: supporting vertical plate, 37: threaded rod, 38: iron ring, 39: hole, and 40: magnetic ring.

### DESCRIPTION OF EMBODIMENTS

To make those skilled in the art better understand the technical solutions of the present application, the following clearly and completely describes the technical solutions in embodiments of the present application with reference to the accompanying drawings in embodiments of the present application. It is clear that the described embodiments are merely a part rather than all of embodiments of the present application. All other embodiments obtained by those of ordinary skill in the art based on embodiments of the present application without creative efforts shall fall within the protection scope of the present application.

The present invention is further illustrated below with reference to the accompanying drawing.

### Embodiment 1

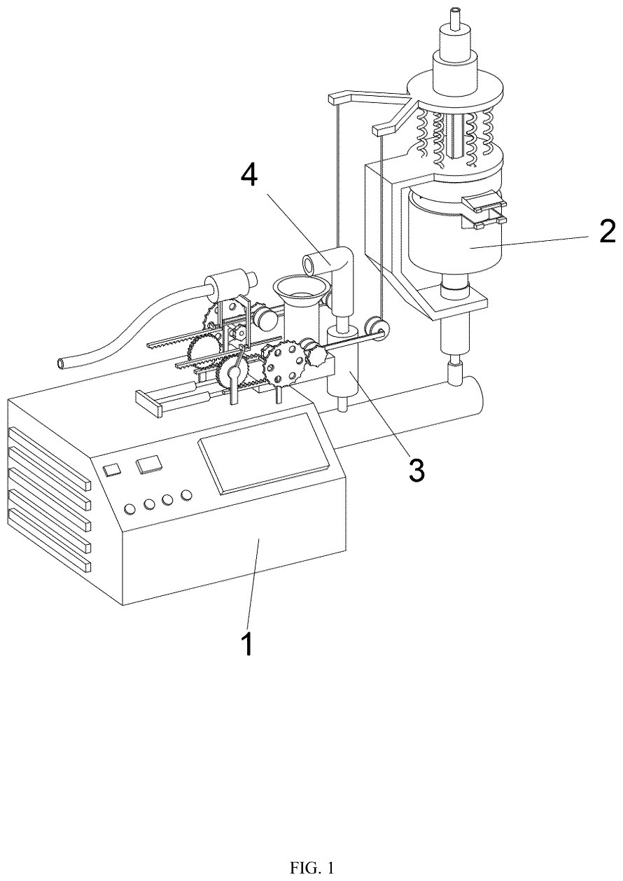

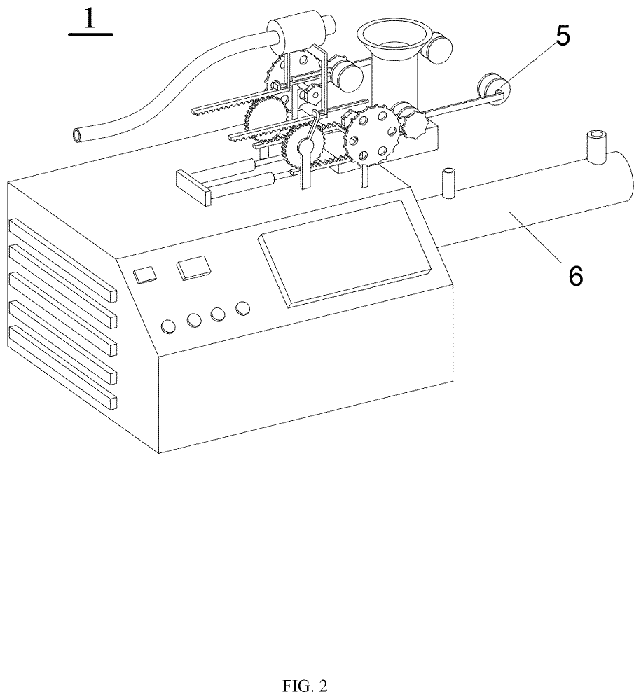

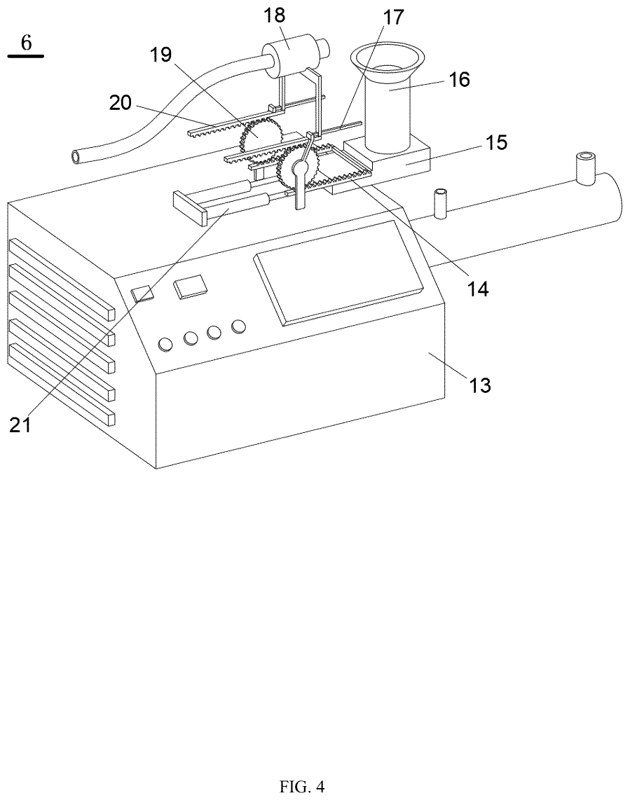

As shown in FIG. 1, FIG. 2 and FIG. 4, a continuous-flow microfluidic homogenization device according to the present invention includes a supporting component 1, wherein a disperser 3 and an aligning component 2 are fixedly mounted at a front end of the supporting component 1, the aligning component 2 is positioned at a front end of the disperser 3, a conveying pipeline 4 is fixedly mounted at a top end of the disperser 3, the supporting component 1 includes synchronizing apparatuses 5 and a transmission apparatus 6, the synchronizing apparatuses 5 are symmetrically and fixedly mounted at a top front end of the transmission apparatus 6, the transmission apparatus 6 includes a microfluidic homogenization device body 13, first racks 14, a placing base 15, a receiving measuring cup 16, an extending base frame 17, a butt joint head 18, a fourth gear 19, a second rack 20 and hydraulic cylinders 21, the hydraulic cylinders 21 are symmetrically and fixedly mounted at a top end of the microfluidic homogenization device body 13, the placing base 15 is fixedly mounted at a front end of the hydraulic cylinder 21, the receiving measuring cup 16 is slidably inserted at a top end of the placing base 15, the first racks 14 are symmetrically and fixedly mounted at a top end of the placing base 15 far away from the receiving measuring cup 16, the fourth gear 19 is rotatably mounted at an opposite side end of the extending base frame 17, a top end of the second rack 20 is slidably sleeved on a top end of the extending base frame 17, and the butt joint head 18 is fixedly mounted between the two second racks 20.

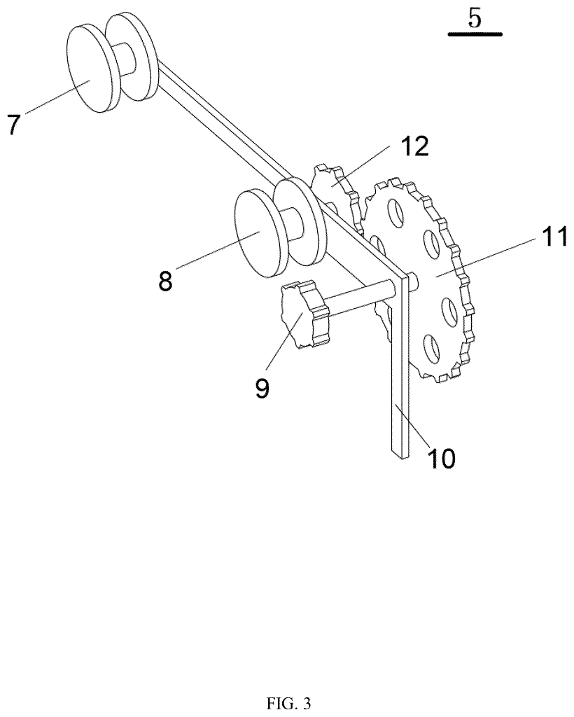

As shown in FIG. 3, the synchronizing apparatus 5 includes a guide wheel 7, a winding wheel 8, a first gear 9, supporting base frames 10, a second gear 11 and a third gear 12, the third gear 12 and the second gear 11 are rotatably mounted at a right top end of the supporting base frame 10, the third gear 12 is positioned in front of the second gear 11, the first gear 9 is fixedly mounted at a left center of the second gear 11, the winding wheel 8 is fixedly mounted at a left center of the third gear 12, and the guide wheel 7 is rotatably mounted at a left front end of the supporting base frame 10. The arrangement of the guide wheel 7 ensures that the connecting rope 24 is used as a base point to vertically pull the supporting top plate 28 to move downwards.

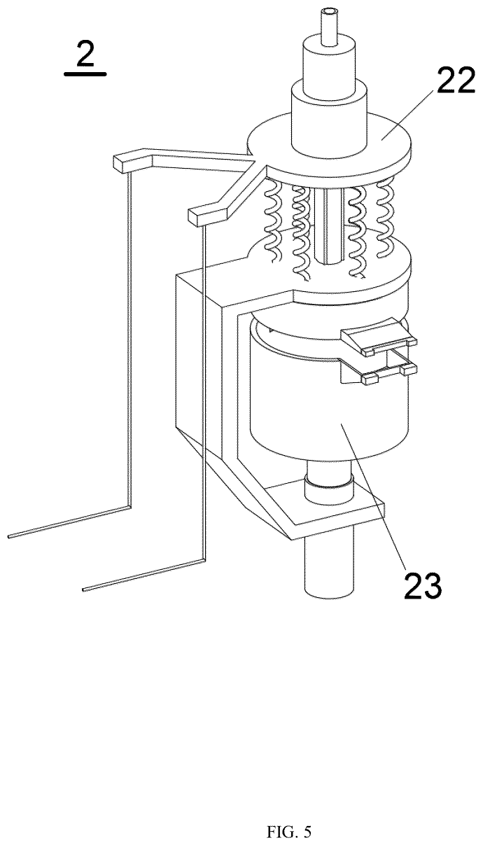

As shown in FIG. 5, the aligning component 2 includes a lower edge apparatus 22 and a receiving apparatus 23, and the lower edge apparatus 22 is fixedly mounted at a top end of the receiving apparatus 23, so that the lower edge apparatus 22 may be supported to work.

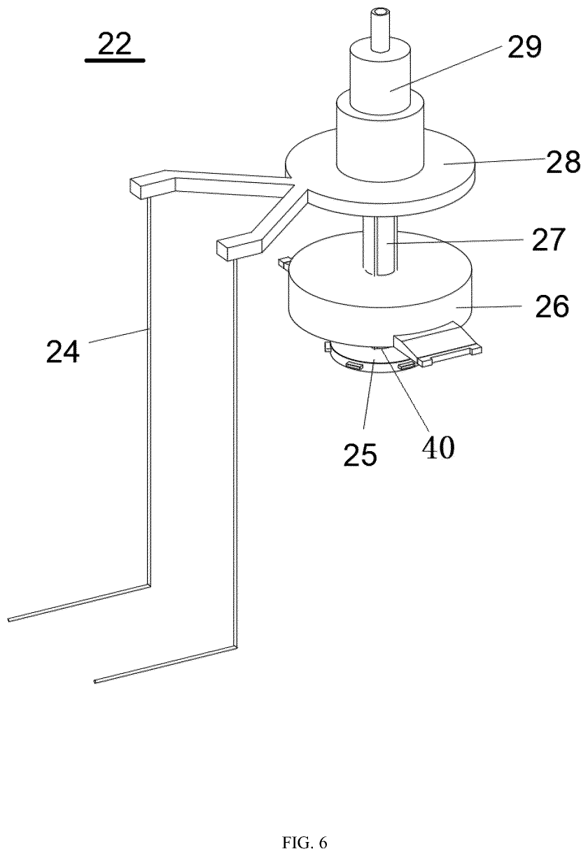

As shown in FIG. 6, the lower edge apparatus 22 includes connecting ropes 24, a nozzle 25, a covering plate 26, a vertical pipe 27, a supporting top plate 28 and an electromagnetic water valve 29, the connecting ropes 24 are symmetrically and fixedly mounted at a bottom rear end of the supporting top plate 28, the electromagnetic water valve 29 is fixedly mounted at a top center of the supporting top plate 28, the vertical pipe 27 is fixedly mounted at a bottom end of the electromagnetic water valve 29, the nozzle 25 is fixedly mounted at a bottom end of the vertical pipe 27, and the covering plate 26 is slidably sleeved on an outer ring of the vertical pipe 27. Clamping plates are fixedly mounted at two sides of the covering plate 26, so that the clamping plates may contact the button switch 32 when the covering plate 26 is attached to the storage cavity 33.

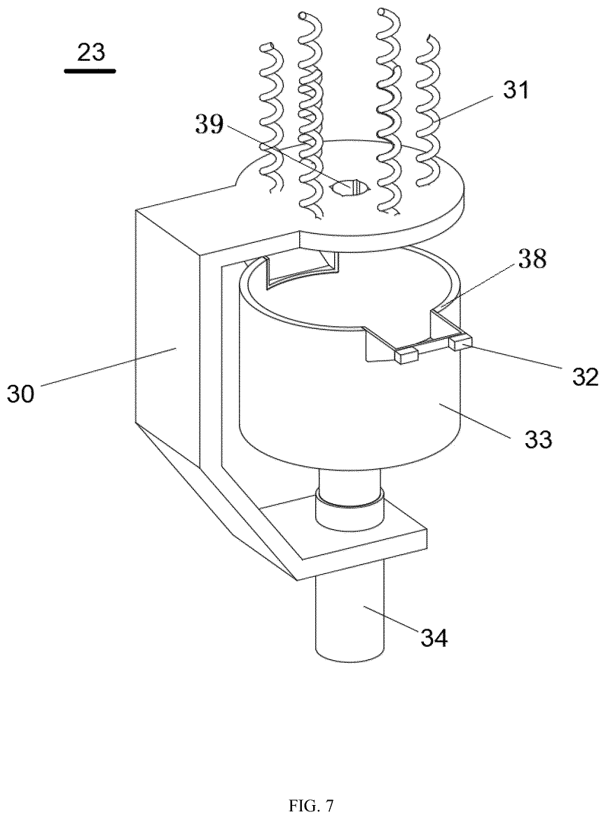

As shown in FIG. 7, the receiving apparatus 23 includes an extending side frame 30, a reset spring 31, button switches 32, a storage cavity 33 and a one-way valve 34, the reset spring 31 is fixedly mounted at a top front end of the extending side frame 30, the reset spring 31 is distributed in a ring shape, the one-way valve 34 is fixedly mounted at a bottom front end of the extending side frame 30, the storage cavity 33 is fixedly mounted at a top of the one-way valve 34, and the button switches 32 are fixedly mounted at top ends of two sides of the storage cavity 33. Filling ports are provided on two sides of the storage cavity 33 to facilitate the addition of liquid into the storage cavity 33. In addition, the button switch 32 is started by a single touch, and each start time is 15 seconds, so that the nozzle 25 can spray water during the descent process. When the 15-second start time has passed, the electromagnetic water valve 29 may be powered off to prevent the nozzle 25 from continuously spraying water.

The supporting base frames 10 are symmetrically and fixedly mounted at a top front end of the microfluidic homogenization device body 13, one end of the connecting rope 24 far away from the nozzle 25 is connected to the winding wheel 8, a top end of the reset spring 31 is connected to a bottom end of the supporting top plate 28, and the one-way valve 34 is fixedly mounted at the top front end of the microfluidic homogenization device body 13. The butt joint head 18 is horizontally aligned to the conveying pipeline 4, the third gear 12 is meshed with the second gear 11, a transmission ratio of the second gear 11 to the third gear 12 is 1:10, and a top end of the first gear 9 is aligned to a bottom end of the second rack 20. An iron ring 38 is fixedly mounted at an outer ring of a top end of the storage cavity 33, a hole 39 adapted to the vertical pipe 27 is opened on a top end of the extending side frame 30, and the button switch 32 is electrically connected to the electromagnetic water valve 29. Each of the second rack 20 and the first rack 14 are meshed with the fourth gear 19, the receiving measuring cup 16, the butt joint head 18 and the conveying pipeline 4 are vertically aligned, and a magnetic ring 40 is fixedly mounted at a bottom end of the covering plate 26.

The working principle of Embodiment 1 is as follows. When in use, a liquid to be processed from the outside is filled into the storage cavity 33 from the filling ports at two sides of the storage cavity 33 close to a top end of the button switch 32, the one-way valve 34 is connected to the inside of the microfluidic homogenization device body 13, and the microfluidic homogenization device body 13 may be started to absorb the liquid inside the storage cavity 33 through the inside of the disperser 3, so that the liquid drops or powder particles in the liquid may be refined to nano-level distribution and evenly distributed inside the liquid, and finally discharged from the conveying pipeline 4. The placing base 15 may be positioned below the conveying pipe 4 when kept in a normal state, and the receiving measuring cup 16 is placed on the top end of the placing base 15, so that the placing base 15 may receive the discharged liquid and complete the liquid processing work. After the liquid is completely discharged, the hydraulic cylinder 21 may be started to drive the placing base 15 to move to the rear end, so that the receiving measuring cup 16 may be moved out from the bottom of the conveying pipe 4. Meanwhile, when the placing base 15 moves toward the rear end, the first rack 14 may be driven to pass the bottom end of the fourth gear 19, thereby driving the second rack 20 to move toward the front end, and the top end of the second rack 20 is slidably sleeved on the extending base frame 17, so that the second rack 20 may be supported to move in a straight line. When the second rack 20 moves toward the front end, the butt joint head 18 may be driven to move toward the front end, so that the butt joint head 18 may be inserted into the interior of the conveying pipe 4. The second rack 20 may also pass through the top end of the first gear 9 when moving toward the front end, thereby driving the first gear 9 and the second gear 11 to rotate simultaneously. When the second gear 11 rotates, the third gear 12 and the winding wheel 8 may be driven to rotate simultaneously, so that the winding wheel 8 may pull the supporting top plate 28 downward by the connecting rope 24, and the vertical pipe 27 is slidably inserted into the top end of the extending side frame 30, so that the vertical pipe 27 may be ensured to move downward in a straight line. Then, the connecting rope 24 passes over the outer ring of the guide wheel 7, so that the connecting rope 24 may pull the supporting top plate 28 downward with the guide wheel 7 as the base point. When moving downward, the vertical pipe 27 may drive the covering plate 26 to be adsorbed and attached to the top end of the storage cavity 33. When the covering plate 26 contacts the storage cavity 33, the electromagnetic water valve 29 may be started by the contact between the clamping plates on two sides of the covering plate 26 and the button switch 32. The electromagnetic water valve 29 is connected to the external water pipe, so that when the button switch 32 is triggered, the electromagnetic water valve 29 may be started, so that water enters the interior of the vertical pipe 27 and is sprayed out by the nozzle 25. When the covering plate 26 is attached to the top end of the storage cavity 33, the nozzle 25 may move to the inside of the storage cavity 33, so that the nozzle 25 may spray water on the inner wall of the storage cavity 33, thereby flushing the residual liquid attached to the inner wall of the storage cavity 33. When the nozzle 25 flushes the inner wall of the storage cavity 33, the covering plate 26 covers the top end of the storage cavity 33, so that water may be prevented from splashing outward. When the covering plate 26 contacts the top end of the storage cavity 33, the supporting top plate 28 may continuously drive the vertical pipe 27 and the nozzle 25 to move downward, so that the nozzle 25 may flush the inside of the storage cavity 33 at different heights. When the supporting top plate 28 moves downward to the extreme position, the nozzle 25 may be driven to be 2 cm apart from the bottom end of the storage cavity 33, so that the nozzle 25 may be prevented from blocking the inside of the storage cavity 33. Then, the microfluidic homogenization device body 13 may be started, so that the water inside the storage cavity 33 may be discharged from the conveying pipe 4 through the inside of the disperser 3. The butt joint head 18 is interconnected with the conveying pipe 4, and a hose is fixedly mounted at the rear end of the butt joint head 18, so that the butt joint head 18 may discharge wastewater from the inside of the butt joint head 18 to the outside, thus completing the cleaning of the storage cavity 33, the internal pipelines of the microfluidic homogenization device body 13, the disperser 3 and the conveying pipe 4. Then, when the butt joint head 18 has discharged the wastewater, the hydraulic cylinder 21 may be started again to drive the placing base 15 to move to the front end, so that the receiving measuring cup 16 may be moved again to be vertically aligned to the conveying pipe 4, so as to facilitate the collection of the processed liquid. In addition, when the placing base 15 moves toward the front end, the fourth gear 19 may be driven to rotate, so that the second rack 20 moves toward the rear end, the butt joint head 18 may be separated from the conveying pipe 4, and the liquid discharged from the conveying pipe 4 may enter the interior of the receiving measuring cup 16. Meanwhile, the second rack 20 passes through the top end of the first gear 9, thus driving the second gear 11 and the third gear 12 to rotate in the opposite direction, so that the winding wheel 8 may release the connecting rope 24, and the elasticity of the reset spring 31 drives the supporting top plate 28 to move upward, and the nozzle 25 may be moved out of the storage cavity 33. When the top end of the nozzle 25 is attached to the inner top of the covering plate 26, the covering plate 26 may be driven to move upward, so that when the nozzle 25 rises, the covering plate 26 may be driven to separate from the storage cavity 33, and the reset work of the supporting top plate 28 is completed.

### Embodiment 2

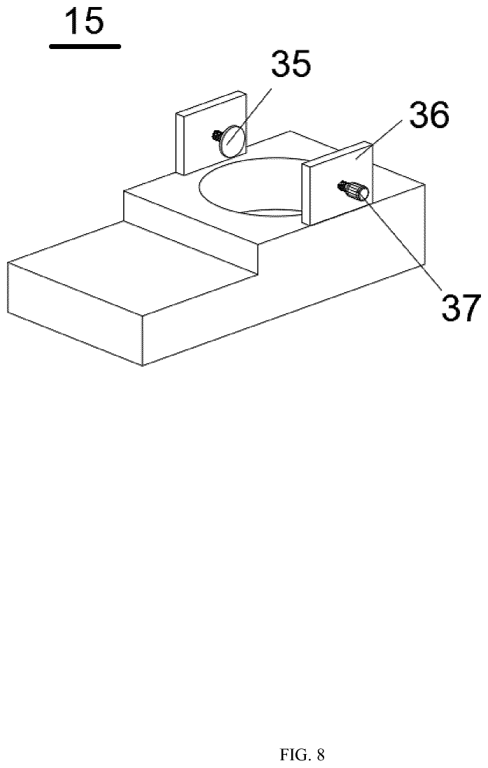

Based on Embodiment 1, as shown in FIG. 8, the placing base 15 includes a plastic gasket 35, a supporting vertical plate 36 and a threaded rod 37, the plastic gasket 35 is fixedly mounted at two sides of a top end of the placing base 15, the threaded rod 37 is threadedly inserted in a center of a side end of the supporting vertical plate 36, and the plastic gasket 35 is fixedly mounted at a center of the opposite end of the threaded rod 37.

In this embodiment, when the receiving measuring cup 16 is placed on the top end of the placing base 15, the threaded rod 37 may be rotated by screwing, so as to drive the plastic gasket 35 to move toward one end close to the receiving measuring cup 16 until the plastic gasket 35 is fastened to the receiving measuring cup 16, which may stably limit the receiving measuring cup 16 on the top end of the placing base 15, thereby preventing the receiving measuring cup 16 from shaking during use. Then, when the receiving measuring cup 16 needs to be taken out, the threaded rod 37 may be rotated by screwing in the opposite direction until the plastic gasket 35 is separated from the receiving measuring cup 16, so as to release the receiving measuring cup 16, thereby facilitating the taking out of the receiving measuring cup 16. A plastic gasket is mounted at the opposite end of the plastic gasket 35, so that the plastic gasket 35 may be prevented from causing damage to the receiving measuring cup 16, and the work is completed.

Although the embodiments of the present invention have been shown and described, it will be understood by those of ordinary skill in the art that various changes, modifications, substitutions and alterations may be made to these embodiments without departing from the principle and spirit of the present invention, and the scope of the present invention is defined in the appended claims and equivalents thereof.

What is claimed is:

1. A continuous-flow microfluidic homogenization device, comprising a supporting component (1), wherein a disperser (3) and an aligning component (2) are fixedly mounted at a front end of the supporting component (1), the aligning component (2) is positioned at a front end of the disperser (3), a conveying pipeline (4) is fixedly mounted at a top end of the disperser (3), the supporting component (1) comprises synchronizing apparatuses (5) and a transmission apparatus (6), the synchronizing apparatuses (5) are symmetrically and fixedly mounted at a top front end of the transmission apparatus (6), the transmission apparatus (6) comprises a microfluidic homogenization device body (13), first racks (14), a placing base (15), a receiving measuring cup (16), an extending base frame (17), a butt joint head (18), a fourth gear (19), a second rack (20) and hydraulic cylinders (21), the hydraulic cylinders (21) are symmetrically and fixedly mounted at a top end of the microfluidic homogenization device body (13), the placing base (15) is fixedly mounted at a front end of the hydraulic cylinder (21), the receiving measuring cup (16) is slidably inserted at a top end of the placing base (15), the first racks (14) are symmetrically and fixedly mounted at a top end of the placing base (15) far away from the receiving measuring cup (16), the fourth gear (19) is rotatably mounted at an opposite side end of the extending base frame (17), a top end of the second rack (20) is slidably sleeved on a top end of the extending base frame (17), and the butt joint head (18) is fixedly mounted between the two second racks (20);
the synchronizing apparatus (5) comprises a guide wheel (7), a winding wheel (8), a first gear (9), supporting base frames (10), a second gear (11) and a third gear (12), the third gear (12) and the second gear (11) are rotatably mounted at a right top end of the supporting base frame (10), the third gear (12) is positioned in front of the second gear (11), the first gear (9) is fixedly mounted at a left center of the second gear (11), the winding wheel (8) is fixedly mounted at a left center of the third gear (12), and the guide wheel (7) is rotatably mounted at a left front end of the supporting base frame (10);
the aligning component (2) comprises a lower edge apparatus (22) and a receiving apparatus (23), and the lower edge apparatus (22) is fixedly mounted at a top end of the receiving apparatus (23);
the lower edge apparatus (22) comprises connecting ropes (24), a nozzle (25), a covering plate (26), a vertical pipe (27), a supporting top plate (28) and an electromagnetic water valve (29) the connecting ropes (24) are symmetrically and fixedly mounted at a bottom rear end of the supporting top plate (28), the electromagnetic water valve (29) is fixedly mounted at a top center of the supporting top plate (28), the vertical pipe (27) is fixedly mounted at a bottom end of the electromagnetic water valve (29), the nozzle (25) is fixedly mounted at a bottom end of the vertical pipe (27), and the covering plate (26) is slidably sleeved on an outer ring of the vertical pipe (27);
the receiving apparatus (23) comprises an extending side frame (30), a reset spring (31), button switches (32), a storage cavity (33) and a one-way valve (34), the reset spring (31) is fixedly mounted at a top front end of the extending side frame (30), the reset spring (31) is distributed in a ring shape, the one-way valve (34) is fixedly mounted at a bottom front end of the extending side frame (30), the storage cavity (33) is fixedly mounted at a top of the one-way valve (34), and the button switches (32) are fixedly mounted at top ends of two sides of the storage cavity (33);
the supporting base frames (10) are symmetrically and fixedly mounted at a top front end of the microfluidic homogenization device body (13), one end of the connecting rope (24) far away from the nozzle (25) is connected to the winding wheel (8), a top end of the reset spring (31) is connected to a bottom end of the supporting top plate (28), and the one-way valve (34) is fixedly mounted at the top front end of the microfluidic homogenization device body (13); and
the butt joint head (18) is horizontally aligned to the conveying pipeline (4), the third gear (12) is meshed with the second gear (11), a transmission ratio of the second gear (11) to the third gear (12) is 1:10, and a top end of the first gear (9) is aligned to a bottom end of the second rack (20).

2. The continuous-flow microfluidic homogenization device according to claim 1, wherein an iron ring (38) is fixedly mounted at an outer ring of a top end of the storage cavity (33), a hole (39) adapted to the vertical pipe (27) is opened on a top end of the extending side frame (30), and the button switch (32) is electrically connected to the electromagnetic water valve (29).

3. The continuous-flow microfluidic homogenization device according to claim 2, wherein each of the second rack (20) and the first rack (14) are meshed with the fourth gear (19), the receiving measuring cup (16), the butt joint head (18) and the conveying pipeline (4) are vertically aligned, and a magnetic ring (40) is fixedly mounted at a bottom end of the covering plate (26).

4. The continuous-flow microfluidic homogenization device according to claim 3, wherein the placing base (15) comprises a plastic gasket (35), a supporting vertical plate (36) and a threaded rod (37), the plastic gasket (35) is fixedly mounted at two sides of a top end of the placing base (15), the threaded rod (37) is threadedly inserted in a center of a side end of the supporting vertical plate (36), and the plastic gasket (35) is fixedly mounted at a center of the opposite end of the threaded rod (37).
